(19) United States
(12) Patent Application Publication
(10) Pub. No.: US 2008/0124153 A1
(43) Pub. Date: May 29, 2008

(54) Image forming apparatus

(75) Inventors: Aya Kakishima, Kanagawa (JP); Junpei Amano, Kanagawa (JP); Yasushi Kawahata, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/806,800

(22) Filed: Jun. 4, 2007

(30) Foreign Application Priority Data
Nov. 27, 2006 (JP) P2006-318601

(51) Int. Cl. G03G 15/20

(52) U.S. Cl. 399/341

(57) ABSTRACT

An image forming apparatus, which forms an image on a recording material using a toner containing a crystalline substance, the image forming apparatus includes: a fusing unit that fuses a toner on the recording material; and a sheet transport device that transports downstream the recording material on which a toner image is fused by the fusing unit, wherein the sheet transport device includes: a rotating member which comes into contact with the toner image fused on the recording material and has in a sheet's width direction a length of at least a sheet's width; and a temperature control unit that controls a temperature of the rotating member within a temperature range in which the crystalline substance is not quenched to become amorphous and which is equal to or lower than a melting point of the crystalline substance based on a measured value of the temperature of the rotating member.

### CROSS-REFERENCE TO RELATED APPLICATION

This application is based on and claims priority under 35 USC 119 from Japanese Patent Application No. 2006-318601 filed Nov. 27, 2006.

### BACKGROUND

### 1. Technical Field

The present invention relates to an image forming apparatus and more particularly to an image forming apparatus in which a sheet transport device is provided downstream of a fusing unit.

### SUMMARY

According to an aspect of the invention, there is provided an image forming apparatus, which forms an image on a recording material using a toner containing a crystalline substance, the image forming apparatus including: a fusing unit that fuses a toner on the recording material; and a sheet transport device that transports downstream the recording material on which a toner image is fused by the fusing unit, wherein the sheet transport device includes: a rotating member which comes into contact with the toner image fused on the recording material and has in a sheet's width direction a length of at least a sheet's width; and a temperature control unit that controls a temperature of the rotating member within a temperature range in which the crystalline substance is not quenched to become amorphous and which is equal to or lower than a melting point of the crystalline substance based on a measured value of the temperature of the rotating member.

### BRIEF DESCRIPTION OF THE DRAWINGS

Exemplary embodiments of the present invention will be described in detail based on the following figures, wherein:

FIG. 1 illustrates a drawing which shows schematically the configuration of an image forming apparatus according to an exemplary embodiment of the invention;

FIG. 2 illustrates a sectional view which shows schematically the configuration of a fusing unit according to the exemplary embodiment of the invention;

FIG. 3 illustrates a drawing which illustrates a sheet transport roller of the exemplary embodiment;

FIG. 4 illustrates a drawing which illustrates a belt transport which is provided downstream of the fusing unit;

FIG. 5 illustrates a drawing which illustrates a resulting relationship between sheet temperature and image gloss irregularity occurrence frequency; and

FIG. 6 illustrates a drawing which illustrates an image forming apparatus in which a belt transport and a transport roller whose temperature is controlled are provided downstream of a fusing unit.

### DETAILED DESCRIPTION

Hereinafter, best modes (embodiments) for carrying out the invention will be described. Note that the invention is not limited to the following embodiments but can be modified variously for implementation without departing from the spirit and scope thereof. In addition, the accompanying drawings are to be used for illustration of the embodiments and are not such as to represent them on an actual scale.

### Exemplary Embodiment 1

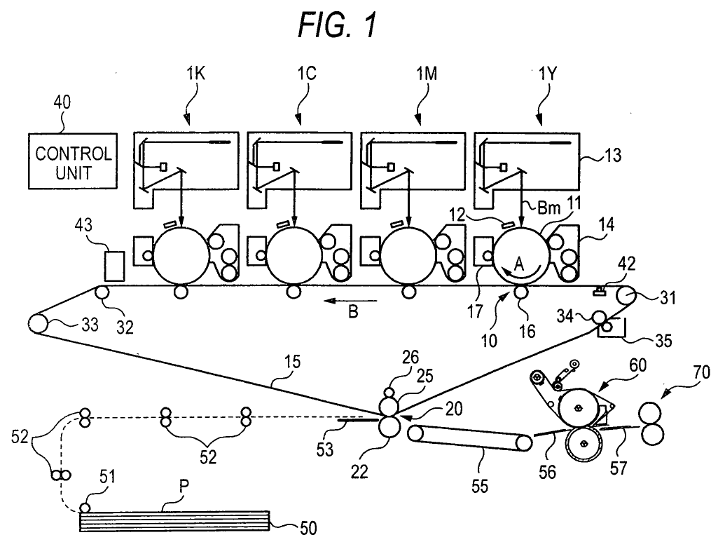

FIG. 1 is a drawing which schematically shows the configuration of an image forming apparatus to which an exemplary embodiment of the invention is applied. The image forming apparatus shown in FIG. 1 is an image forming apparatus utilizing an intermediate transfer method which is generally referred to as a tandem-type image forming apparatus and includes a plurality of image forming units 1Y, 1M, 1C, 1K in which toner images of relevant color components are formed through electrophotography, primary transfer sections 10 for causing the toner images of relevant color components which have been formed by the image forming units 1Y, 1M, 1C, 1K, respectively, to be transferred sequentially (a primary transfer) on to an intermediate transfer belt 15, a secondary transfer section 20 for causing a superposed toner image made up of the toner images which have been transferred on to the intermediate transfer belt 15 in a superposed fashion to be transferred altogether (a secondary transfer) on to a sheet of paper P which is a recording material (a recording sheet), a fusing unit 60 for fusing the resulting image from the secondary transfer on the sheet P, and a sheet transport roller 70 as a sheet transport device for transporting the sheet P on which the image has been so fused. In addition, the image forming apparatus has a control unit 40 for controlling operations of the respective units (respective sections).

In this exemplary embodiment, in each of the image forming units 1Y, 1M, 1C, 1K, electrophotographic devices are sequentially provided on the periphery of a photoconductor drum 11 which rotates in a direction indicated by an arrow A which include a charging device 12 for charging the photoconductor drum 11, a laser exposure device 13 for writing a latent image on the photoconductor drum 11 (in the figure, an exposure beam is denoted by a reference character Bm), a developing device 14 which accommodates a corresponding color component to visualize the latent image on the photoconductor drum 11 by the toner so accommodated, a primary transfer roller 16 for transferring a toner image of the relevant color component which is formed on the photoconductor drum 11 on to the intermediate transfer belt 15 at the primary transfer section 10, a drum cleaner 17 where the residual toner on the photoconductor drum 11 is removed, and the like. These image forming units 1Y, 1M, 1C, 1K are disposed substantially in a straight-like fashion sequentially in the order of yellow (Y), magenta (M), cyan (C) and black (K) from an upstream side of the intermediate belt 15.

The intermediate transfer belt 15, which is an intermediate transfer unit, is driven to circulate (rotate) in a direction indicated by an arrow B in FIG. 1 at a predetermined speed by various types of rollers. The various types of rollers include a drive roller 31 which is driven to rotate the intermediate belt 15 by a motor (not shown) which has the superior constant rate properties, support rollers 32 which support the intermediate transfer belt 15 which extends in substantially straight line along a direction in which the respective photoconductor drums 11 are aligned, a tension roller 33 which imparts a constant tension to the intermediate transfer belt 15 and functions as a correcting roller for preventing the intermediate transfer belt 15 from snaking, a backup roller 25 which is provided at the secondary transfer section 20 and a cleaning backup roller 34 which is provided at a cleaning section where the residual toner on the intermediate transfer belt 15 is removed.

The primary transfer section 10 is made up of the primary transfer roller 16 which is disposed in such a manner as to oppositely face the photoconductor drum 11 across the intermediate transfer belt 15. Then, the primary transfer roller 16 is disposed in press contact with the photoconductor drum 11 across the intermediate transfer belt 15 or with it interposed therebetween, and furthermore, it is configured that a voltage of an opposite polarity (a primary transfer bias) to a charge polarity of the toner (which is a negative polarity, this being true hereinafter) is applied to the primary transfer roller 16, whereby respective toner images on the photoconductor drums 11 are electrostatically attracted on to the intermediate transfer belt 15 in a sequential fashion, so that a superposed image is formed.

The secondary transfer section 20 is made up of a secondary transfer roller 22 which is disposed on a toner image carrying surface side of the intermediate transfer belt 15 and the backup roller 25. The backup roller 25 is disposed on a rear surface side of the intermediate transfer belt 15 so as to constitute an opposite electrode to the secondary transfer roller 22, and a metallic feeding roller 26, to which a secondary transfer bias is applied in a stable fashion, is disposed in press contact with the backup roller 25.

On the other hand, the secondary transfer roller 22 is disposed in press contact with the backup roller 25 across the intermediate transfer roller 15, and furthermore, the secondary transfer roller 22 is grounded, whereby a secondary transfer bias is formed between the backup roller 25 and itself, so that the toner image is secondarily transferred on to a sheet of paper P which is transported to the secondary transfer section 20.

In addition, an intermediate transfer belt cleaner 35 is provided along the intermediate transfer belt 15 downstream of the secondary transfer section 20 in such a manner as to be brought into contact with and released from the intermediate transfer belt 15 freely so as to clean a surface of the intermediate transfer belt 15 by removing the residual toner and paper dust which remain on the intermediate transfer belt 15 after the secondary transfer of the image. On the other hand, a reference sensor (a home position sensor) 42 is disposed upstream of the yellow image forming unit 1Y which generates a reference signal which constitutes a base for taking an image forming timing in each of the image forming units 1Y, 1M, 1C, 1K. In addition, an image density sensor 43 is provided downstream of the black image forming unit 1K which adjusts the quality of a superposed image formed by the image forming units. The reference sensor 42 generates a reference signal by recognizing a predetermined mark provided on the rear side of the intermediate transfer belt 15, and the respective image forming units 1Y, 1M, 1C, 1K are configured to start image formation by receiving instructions issued from the control unit 40 based on the recognition of the reference signal so generated.

Furthermore, in the image forming apparatus of this exemplary embodiment, there are provided as a sheet transport system a sheet tray 50 which accommodates sheets of paper P, a pickup roller 51 which picks up a sheet P from sheets stacked in pile in the sheet tray 50, transport rollers 52 which transport the sheet P which is fed out by the pickup roller 51, a transport chute 53 which sends the sheet P transported by the transport rollers 52 into the secondary transfer section 20, a transfer belt 55 which transports the sheet P which is transported out from the secondary transfer section 20 after a secondary transfer has been completed thereon to the fusing unit 60, a fusing entrance guide which guides the sheet P into the fusing unit 60, and a discharge guide which guides the sheet P on which the image has been fused by the fusing unit 60 to a sheet transport roller 70.

Next, a basic image creating process of the image forming apparatus to which the invention is applied will be described.

In the image forming apparatus as is shown in FIG. 1, image data that is outputted from an image pickup apparatus or image input terminal (IIT), not shown, or a personal computer, not shown, is subjected to a predetermined image processing by an image processing system (IPS), and thereafter, image creating operations are performed by the image forming units 1Y, 1M, 1C, 1K, respectively. In the IPS, a predetermined image processing is applied to inputted reflectance data, the predetermined image processing including various types of image editing such as shading correction, positional deviation correction, lightness/color space conversion, gamma correction, frame deletion and color editing, and shift editing. The image data to which the image processing has been so applied is then converted into color material gradation data of four colors of Y, M, C, K, and the converted data is then outputted to the laser exposure device 13.

In the exposure device 13, for example, an exposure beam BM which is outputted from a semiconductor later is shone on to the respective photoconductor drums 11 of the image forming units 1Y, 1M, 1C, 1K according to the color material gradation data so inputted. In the respective photoconductor drums 11 of the image forming units 1Y, 1M, 1C, 1K, the surfaces thereof are charged by the charging devices 12, and thereafter, the surfaces are scanned by the laser exposure devices 13, whereby latent images are formed on the photoconductor drums 11, respectively. The latent images so formed are developed as toner images of respective colors of Y, M, C, K by the developing devices 14, respectively.

The toner images formed on the photoconductor drums 11 of the image forming units 1Y, 1M, 1C, 1K are transferred on to the intermediate transfer belt 15 in the primary transfer sections 10 where the respective photoconductor drums 11 and the intermediate transfer belt 15 are brought into abutment with each other. To described more specifically, in the primary transfer section 10, a voltage (a primary transfer bias) of an opposite polarity (a positive polarity) to the charge polarity of the toner is applied to a base material of the intermediate transfer roller 15 by the primary transfer roller 16, whereby a primary transfer is performed in which the toner images are primarily transferred on to the surface of the intermediate transfer belt 15 in such a manner as to be superposed one on another.

After the toner images have been primarily transferred on to the surface thereof sequentially as a superposed image, the intermediate transfer belt 15 continues to move to transport the superposed toner image to the secondary transfer section 20. When the toner image is transported to the secondary transfer section 20, in the sheet transport system, the pickup roller 51 rotates in synchronism with a timing at which the toner image is transported to the secondary transfer section 20, whereby a sheet of paper P of a predetermined size is supplied. The sheet P supplied by the pickup roller 51 is transported by the transport rollers 52 and reaches the secondary transfer section 20 via the transport chute 53. The sheet P is stopped temporarily before it reaches the secondary transfer section 20, so that the position of the sheet P is aligned with the position of the toner images by a registration roller (not shown) which rotates in synchronism with a timing at which the intermediate transfer belt 15 moves which carries the toner images.

In the secondary transfer section 20, the secondary transfer roller 22 is pressed on to the backup roller 25 via the intermediate transfer belt 15. As this occurs, the sheet P, which has been transported in synchronism with the timing, is held between the intermediate transfer belt 15 and the secondary transfer roller 22. As this occurs, a voltage (a secondary transfer bias) of the same polarity (a negative polarity) as the charge polarity of the toner is applied from the feeding roller 26, a transfer electric field is formed between the secondary transfer roller 22 and the backup roller 25. Then, the unfused toner images, which now form the unfused superposed image, are electrostatically transferred altogether on to the sheet P in the secondary transfer section 20 where the toner images are pressed on to the sheet P.

Thereafter, the sheet P, on to which the superposed toner image has been electrostatically transferred, is transported as it is by the secondary transfer roller 22 in such a state that the sheet P is released from the intermediate transfer belt 15 and is transported to the transport belt 55 which is provided downstream of the secondary transfer roller 22 in the sheet transport direction. The transport belt 55 transport the sheet P to the fusing unit 60 at an optimum transport speed which matches a transport speed in the fusing unit 60. The unfused toner image on the sheet P which has been transported to the fusing unit 60 is then subjected to a fusing processing by the fusing unit in which heat and pressure are applied to the unfused toner image, whereby the unfused toner image is fused on the sheet P. Then, the sheet P, on which the fused image is formed, is transported to a discharged sheets resting portion (not shown) which is provided in a discharge unit of the image processing apparatus via the sheet transport roller 70.

On the other hand, after the transfer of the toner image on to the sheet P has been completed, the residual toner which remains on the intermediate transfer belt 15 continues to be transported to the cleaning backup roller 34 and the intermediate transfer belt cleaner 35 as the intermediate transfer belt 15 continues to rotate, whereby the residual toner is removed by the cleaning backup roller 34 and the intermediate transfer belt cleaner 35.

### (Fusing Unit)

Next, the fusing unit 60 will be described.

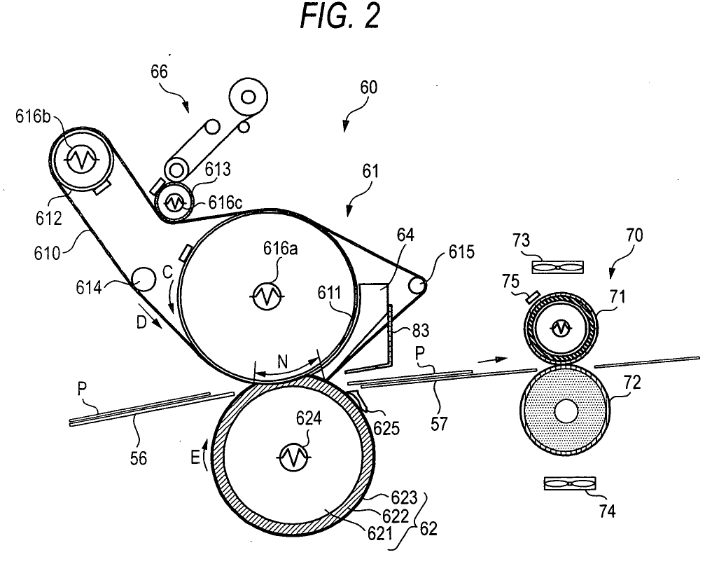

FIG. 2 is a sectional view showing schematically the configuration of the fusing unit 60 which constitutes the exemplary embodiment of the invention. This fusing unit 60 includes the fusing belt module 61 as a main part. In addition, the fusing unit 60 also includes as a main part the impression roller 62 which is formed into a roller shape as an example of a pressurizing member which is disposed in such a manner as to be pressed on to the fusing belt module 61.

In addition, the sheet transport roller 70 is provided downstream of the fusing unit 60 which transports the sheet P on which the fused image is formed to the discharged sheets resting portion (not shown) which is provide in the discharge unit of the image forming apparatus. The sheet transport roller 70 has at least a width equal to the width of the sheet in the axial direction thereof and includes an upper roller 71, a lower roller 72, cooling fans 73, 74, and a temperature sensor 75. The sheet transport roller 70 will be described later on.

The fusing belt module 61 includes a fusing belt 610 as an example of a belt member, a cylindrically formed fusing roller 611 which driven to rotate in a direction indicated by an arrow C while stretching the fusing belt 610, and a tension roller (a steering roller) 612 as a stretching member for stretching the fusing belt 610 from the inside thereof. In addition, the fusing belt module 61 includes a tension roller 613 which stretches the fusing belt 610 from the outside thereof and a posture correction roller 614 which is driven to rotate between the fusing roller 611 and the tension roller 612 in such a manner as to follow the rotation of the fusing belt 610 in a direction indicated by an arrow D and which corrects the posture of the fusing belt 610.

Furthermore, the fusing belt module 61 includes a release pad 64 as an example of a release member which is disposed in a downstream side region within a nip section N where the fusing belt module 61 and the impression roller 62 are in press contact with each other and in a position lying in the vicinity of the fusing roller 611.

In addition, the fusing belt module 61 includes a tension roller (an idler roller) 615 which stretches the fusing belt 610 downstream of the nip section N. In addition, the fusing belt module 61 includes a cleaning web 66 for cleaning the surface of the tension roller 613.

The fusing belt 610 is a flexible endless belt. In addition, the fusing belt 610 is made up of a base layer which is made from a polyimide or the like and which has a thickness of the order of 80 μm, an elastic layer which is made from a silicone rubber or the like and is laminated on a front surface side (an outer circumferential surface side) of the base layer and which has a thickness of the order of 50 μm, and a release layer which is made from PFA or the like and is coated over the elastic layer and which has a thickness of the order of 30 μm. The fusing belt 610 moves (rotates) in the direction indicated by the arrow D as the fusing roller 611 rotates.

The fusing roller 611 receives driving force from a predetermined drive device (not shown) to rotate in the direction indicated by the arrow C. In addition, a heater 616a, which functions as a heating source, is provided in an interior of the fusing roller 611.

In addition, the tension roller 612 is a cylindrical roller, and a heater 616b, which functions as a heating source, is provided in an interior thereof. Consequently, the tension roller 612 has a function to heat the fusing belt 610 from an inner circumferential surface side thereof as well as a function to stretch the fusing belt 610. In addition, spring members (not shown) are provided at end portions of the tension roller 612, respectively, in such a manner as to press the fusing belt 610 outwards, so as to impart a tension to the whole fusing belt 610.

Furthermore, the tension roller 613 is a cylindrical roller, and a heater 616c, which functions as a heating source, is provided in an interior thereof. Because of this, the tension roller 613 has a function to heat the fusing belt 610 from an outer circumferential surface side thereof as well as a function to stretch the fusing belt 610. Consequently, in this exemplary embodiment, a configuration is adopted in which the fusing belt 610 is heated by the fusing roller 611, the tension roller 612 and the tension roller 613.

In addition, the impression roller 62 is made up of a cylindrical roller 621 as a base element. Then, an elastic layer 622 and a release layer 623 are sequentially laminated on the cylindrical base roller 621 in that order from the base element side so as to make up a soft roller. In addition, the impression roller 62 is set in such a manner as to be pressed by the fusing belt module 61. As the fusing roller 611 of the fusing belt module 61 rotates in the direction indicated by the arrow C, following the rotation of the fusing roller 611, the impression roller 62 rotates in a direction indicated by an arrow E. In addition, a heater 624, which functions as a heating source, is provided in an interior of the impression roller, whereby the impression roller 62 is heated to a predetermined temperature.

The fusing unit 60 includes a guide member 83 which guides a sheet discharged from the nip section N to a sheet discharge device (not shown). The guide member 83 is mounted spaced apart from the fusing belt 610 with a predetermined space secured therebetween in such a manner as to swing together with the release pad 64 about a rotating axis of the fusing roller 611. In addition, a release claw 625 is provided below the guide member 83.

Here, the release pad 64 is provided downstream and in the vicinity of the nip section N with a predetermined space secured between the fusing roller 61 and itself and presses the fusing belt 610 to a surface of the impression roller 62.

The release pad 64 is formed substantially into an arc-like shape which extends along a circumferential direction of the fusing roller 611 in section and is disposed in the axial direction of the fusing roller 611 in a position which lies downstream and in the vicinity of the nip section N. Then, after having passed through the nip section N, the fusing belt 610 rotates along a side surface of the release pad 64, whereby a traveling direction of the fusing belt 610 is drastically changed in such a manner as to be bent into the direction of the tension roller 615 by the release pad 64, and a sheet is released from the fusing belt 610 by virtue of a so-called “nerve” of its own. The traveling direction of the sheet which is released from the fusing belt 610 is guided by the guide member 83 which is provided downstream of the nip section N.

In addition, the release pad 64 of the exemplary embodiment is a block member having substantially an arc-like shape in section which is formed of a rigid element of, for example, an SUS metal or a resin. Additionally, the release pad 64 is disposed in such a manner as to uniformly press the impression roller 62 via the fusing belt 610 over a predetermined width region (for example, a width of 2 mm to 10 mm along the traveling direction of the fusing belt 610) with a predetermined load (for example, 10 kgf).

### (Toner)

Here, color toner of the respective color components developed in the respective developing devices 14 (refer to FIG. 1) of the image forming units 1Y, 1M, 1C, 1K of the exemplary embodiment contains a binder resin such as a polyester resin, a coloring agent such as a dye or a subliming dye, a releasing agent such as a wax, or additives such as a charge control agent and the like which are added according to other objects.

Although not limited thereto, there are raised as a method for manufacturing those toners, for example, a kneading and pulverizing method in which a binder resin, a coloring agent and an additive are kneaded and thereafter are pulverized; a suspending and polymerizing method in which a coloring agent, a releasing agent and the like are suspended together with a polymerizable monomer so as to polymerize a polymerized monomer; a dissolving and suspending method in which toner constituent materials such as a binder resin, a coloring agent, a releasing agent and the like are dissolved in an organic solution, and the organic solution is removed after the toner materials are dispersed in a water-based solvent in a suspension state; and an emulsion polymerization and coagulation fusion combining method in which a resin is prepared by emulsion polymerization, the resin so prepared is subjected to heterocoagulation together with a dispersion liquid of a pigment, a releasing agent and the like, and thereafter, the resulting resin is fused and combined.

### (Wax)

Toners used in this exemplary embodiment contain, for example, a wax as a substance having a crystalline structure. In general, when a wax is caused to be contained in a toner, the wax functions as a releasing agent, whereby a greater fusing latitude can be obtained even when a releasing oil is not used on the surface of the fusing belt 610 provided in the fusing unit 60. Here, the fusing latitude means a temperature region ranging from a temperature on a low temperature side (a minimum fusing temperature) at which an unfused toner image can be fused on to a sheet of paper P which is a recording medium to a temperature of a high temperature side (an offset generating temperature) at which the toner image cannot be released from the fusing belt 610, when the temperature of the fusing belt 610 is changed.

It is suitable that an added amount of a wax as a releasing agent is normally in the range of 0.5 wt % to 50 wt %, preferably 1 wt % to 30 wt %, and more preferably 5 wt % to 15 wt % relative to a toner. An advantage of adding the releasing agent can be obtained within the ranges. In addition, since the exposure amount on the toner surface become appropriate, the fluidity and charging characteristics are improved.

In addition, the melting point of wax is normally in the range of 40° C. to 150° C. and preferably 50° C. to 120° C. By setting the melting point of the wax lower than the melting point of a binder resin in the toner to some extent, the wax melts out of the toner earlier than the binder resin in an effective fashion, whereby the releasing performance resulting at an exit of the nip section N of the fusing unit 60 when releasing occurs can be increased.

As the wax like this, low molecular weight polyolefin waxes can be exemplified such as a polyethylene, polypropylene, polybutene and the like.

The following known materials can be added to the toners used in this exemplary embodiment as required in addition to the waxes described above. As the releasing agents like this, there can be raised as waxes, vegetable-based waxes including carnauba wax, cotton wax, wood wax, rice wax and the like; animal waxes including beeswax, lanolin and the like; mineral waxes including ozokerite, ceresin and the like; and petrol waxes including paraffin wax, microcrystalline wax, petrolatum and the like.

In addition to the natural waxes, synthetic hydrocarbon waxes can be used which include Fischer Tropsch wax, polyethylene wax and the like and synthetic waxes can be used which are made from 12-hydroxy stearic acid amide, stearic acid amide, phthalic anhydride imide, fatty amide such as chlorinated hydrocarbon, ester, ketone, ether and the like.

Furthermore, poly acrylate polymers including poly n-stearyl methacrylate, poly n-lauryl methacrylate and the like can be used.

### (Binder Resin)

As the binder resin in the toners, there is no limitation, provided that a binder resin has a crystalline structure therein, and materials can be used which are generally used as binder resins for toners. Binder resins like these include polyester resin, styrene resin, acrylic resin, styrene-acrylic resin, silicone resin, epoxy resin, diene-based resin, phenol resin, ethylene-vinyl acetate resin.

### (Sheet Transport Roller)

Next, the sheet transport roller 70 will be described.

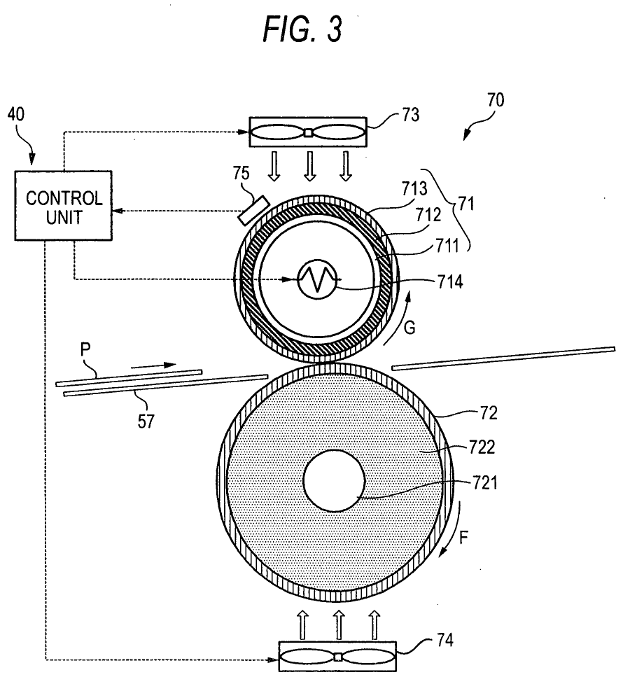

FIG. 3 is a drawing which illustrates the sheet transport roller 70 in the exemplary embodiment. The sheet transport roller 70, which is provided downstream of the fusing unit 60 (refer to FIG. 2), is a rotating member which has an axial length which is, at least, equal to the width of the sheet P and includes the upper roller 71 which rotates while in contact with the toner image fused on the sheet P and the lower roller 72 which is in contact with the upper roller 71.

In addition, the sheet transport roller 70 includes, as a temperature control unit which controls the surface temperature of the sheet transport roller 70 to fall within a predetermined temperature range, a heating halogen lamp 714 which is incorporated in the upper roller 71 as a heating source, the cooling fans 73, 74 which cools the two rollers of the upper roller 71 and the lower roller 72, and the non-contact type temperature detection sensor 75 for detecting the surface temperature of the upper roller 71.

Note that the temperature detection sensor 75 is preferably the non-contact type. In the case of a temperature detection sensor of a contact type, a mark tends to be easily made on the surface of the upper roller 71, leading to a fear that a resulting image is disrupted.

The upper roller 71 is made up of a metallic cylindrical roller core material 711 which made of aluminum, stainless steel or the like, an elastic material layer 712 which is formed of an elastic material such as a silicone rubber or the like on the roller core material 711, and a surface layer 713 which is formed from a fluorine resin (PFA or the like) on a surface of the elastic layer 712. In addition, the heating halogen lamp 714 is provided in an interior space of the roller core material 711.

The thickness of the elastic layer 712 is in the range of the order of 0.5 mm to 5 mm, and the thickness of the surface layer 713 is in the range of the order of 10 μm to 200 μm.

The lower roller 72 is made up of a metallic core metal 721 and a coating layer 722 which is formed on the core metal 721.

Next, the operation of the sheet transport roller 70 will be described.

In this exemplary embodiment, the lower roller 72 is supported rotatably on a predetermined support frame (not shown) and is driven to rotate in a predetermined direction (F) by a known rotational driving device. In addition, the upper roller 71 is driven to rotate in a predetermined direction (G) in conjunction with rotation of the lower roller 72.

In this exemplary embodiment, the temperature of the sheet transport roller 70 is held within the predetermined temperature range by the temperature control unit. Namely, the upper roller 71 is heated until a predetermined heating temperature has been reached by the heating halogen lamp 714, and the sheet transport roller 70 is heated by the cooling fans 73, 74. Then, the heating operation by the heating halogen lamp 714 and the cooling operation by the cooling fans 73, 74 are feedback controlled by the control unit 40 based on detection information by the temperature detection sensor 75 for detecting the surface temperature of the upper roller 71, so that the surface of the sheet transport roller 70 is held at the predetermined temperature.

Here, in general, when the wax or the crystalline resin contained in the toner which is heated to the fusing temperature (for example, 120° C. to 150° C.) is quenched by being brought into contact with the sheet transport roller 70 while the wax or the crystalline resin keeps a high temperature state, the wax or the crystalline resin becomes amorphous, and a resulting image becomes highly glossy.

Because of this, in this exemplary embodiment, the sheet transport roller 70 is heated by virtue of the heating operation of the heating halogen lamp 714, which is the heating source, to such a temperature range that the wax or the crystalline resin is not quenched to become amorphous even by being brought into contact with the sheet transport roller 70.

In addition, normally, since the surface temperature of the sheet transport roller 70 is increased as a result of continuous passage of sheets therethrough (for example, the temperature is increased from 30° C. to on the order of 100° C. as a result of continuous passage of the order of 20 sheets), there may sometimes occur a case where a gloss difference is produced within a series of image forming operations.

Because of this, in this exemplary embodiment, the sheet transport roller 70 is cooled by virtue of the cooling operations of the cooling fans 72, 73 in such a manner that the sheet transport roller 70 is not heated to the temperature at which the gloss difference is generated within the series of image forming operations.

To describe this specifically, the sheet transport roller 70 of the exemplary embodiment is controlled to be held within a temperature range which is lower than a melting point (° C.) or a softening point (° C.) of the wax or the crystalline resin which is contained in the toner used by virtue of feedback control of the detection information detected by the temperature detection sensor 75 by the control unit. The temperature of the sheet transport roller 70 is preferably controlled to be held within a temperature range of a temperature lower by 10° C. than a melting point (° C.) or a softening point (° C.) of the wax or the crystalline resin to the melting point (° C.) or the softening point (° C.).

To be more specific, the temperature of the sheet transport roller 70 is controlled to be held normally in a temperature range of 40° C. to 140° C., preferably 40° C. to 110° C., and more preferably 50° C. to 80° C.

In addition, in the sheet transport roller 70 in this exemplary embodiment, the upper roller 71, which is brought into contact with the toner image formed on the sheet P, is formed using the elastic material layer 712 which is made up of the elastic material. In this way, by providing the elastic material layer 712 to the roller on the image surface side of the sheet transport roller 70, the surface of the roller can be tightly secured to the toner image, and as a result, an image disturbance can be prevented.

In addition, in the exemplary embodiment of the invention, the device which transport sheets of paper P using the pair of rollers is described as the sheet transport roller 70, the transport of sheets is not limited to the transport utilizing the rollers. For example, sheets can be transported by a belt member which is combined with a predetermined impression member. In this case, too, however, a surface of the belt member which lies on an image surface side thereof which is brought into contact with the toner image preferably has an elastic material layer which is made up of an elastic material as has been describe above.

In addition, while the case is described in which the cooling fans 73, 74 are used as the cooling device, it is also possible to cool the sheet transport roller 70 by means of fin cooling which utilizes a predetermined heat pipe.

Thus, with the sheet transport roller 70 according to the exemplary embodiment, a uniform image in which the image gloss is not changed can be obtained by controlling the temperature of the sheet transport roller 70 to fall within the temperature range which is equal to or lower than the melting point or the softening point of the wax or the crystalline resin which is contained in the toner used.

Namely, conventionally, when a toner which contains a wax is used, a strip of high gloss (a roller mark) is generated on a surface of a sheet on which a toner image is formed, and this tendency has been remarkable, in particular, on a high-speed image forming apparatus whose processing speed is on the order of 200 mm/s. A cause for this phenomenon is that since the position of the strip of high gloss coincides with the position of the sheet transport roller which is provided downstream of a fusing unit, the wax or the crystalline resin in the toner which is still in a high temperature state due to not much time having elapsed since the sheet passed through the fusing unit is smoothed only in portions which have been brought into contact with the sheet transport roller and as a result, the surface of the toner image becomes glossy. In particular, it has been found out that since, when the toner which contains a wax or a crystalline resin is brought into contact with the sheet transport roller of a low temperature, the wax or the crystalline resin which is so quenched becomes amorphous, the toner image becoming highly glossy.

On the other hand, although the problem of the roller mark like this can be solved by increasing the roller width of the sheet transport roller to a length which is longer than the width of recording sheets, for example, in the event that the image forming apparatus is restarted after a long downtime, there has been caused a problem that the gloss value of a resulting toner image is increased.

In addition, there has also been caused a problem that when sheets are passes through the sheet transfer roller continuously, the gloss difference in toner image is generated within the series of image forming operations.

The image forming apparatus which includes the sheet transport roller 70 according to the exemplary embodiment is such as to solve the problems which are inherent in the related art.

### Exemplary Embodiment 2

Next, in a case where a toner containing a wax or a crystalline resin is used, an image forming apparatus according to another exemplary embodiment of the invention will be described in which the ununiformity in image gloss is reduced.

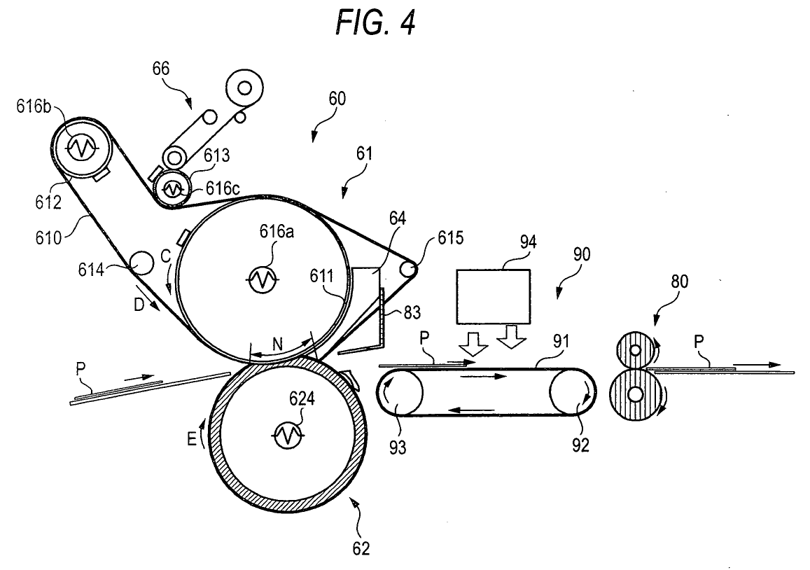

FIG. 4 is a drawing which illustrates a belt transport 90 provided downstream of a fusing unit 60. Note that the fusing unit 60 is identical to that described in detail by reference to FIG. 2, and therefore, the description thereof will be omitted here.

The belt transport 90 shown in FIG. 4 includes a transport belt 91 which is an endless belt for transporting a sheet of paper P, a drive roller 92 for rotating the transport belt 91, a tension roller 93 which stretches the transport belt 91 together with the drive roller 92 and is driven to rotate in association with rotation of the drive roller 92, and a cooling device 94 which blows air down on to the transport belt 91 from thereabove to press the sheet P on to the transfer belt 91 and functions as a cooling device for the sheet P. In addition, a discharge roller 80 is provided further downstream of the transport belt 91 for discharging the sheet P on to a discharge tray (not shown) while holding the sheet P between a pair of rollers.

In this exemplary embodiment, an airflow which presses the sheet P on to the transport belt 91 is formed by air blown out from the cooling device 94. In this way, it is desirable with a view to attaining uniform cooling and reducing the possibility of curling of the sheet P that the airflow for cooling the sheet P is preferably formed in such a manner as to also function to press the sheet P on to the transport belt 91 of the belt transport 90, so as to stabilize the tight securing of the transport belt 91 to the sheet P.

Here, a plurality of holes are provided in a surface of the transport belt 91 as required in such a manner that air flows therethrough, and furthermore, a suction device (not shown) is provided downstream of the transport belt 91, whereby the sheet P can be made to stick to the transport belt 91.

Next, as is shown in FIG. 4, the transport belt 91 transports the sheet P which is sticking to the belt surface to the discharge roller 80 which lies downstream thereof by virtue of the driving of the drive roller 92 and causes the sheet P so transported to be discharged on to a discharge tray (not shown) by the discharge roller 80.

Here, the belt transport 90 transports the sheet P with a reverse (opposite) surface of the sheet P to a surface (a toner surface) thereof on which a toner image, which is fused by the fusing unit 60, exists brought into contact with the transfer belt 91. Because of this, when the toner image on the toner surface of the sheet P reaches the position of the discharge roller 80, the toner image comes into contact with the contact member for the first time since the toner image was fused.

Namely, the surface (the toner surface) of the sheet P which has been brought into contact with a fusing belt 610 of the fusing unit 60 so as to be heated and pressurized and, hence, on which the toner image exists which is fused on the sheet P lies to face upwards, and this toner surface is transported by the transport belt 91 immediately after the toner surface is heated by the fusing unit 60. When transported by the transport belt 91, no transport member exists on the toner surface side, and hence, the toner surface comes in no case into contact with any contact member.

Thereafter, when the toner surface has arrived at a discharge position where the sheet is discharged by the discharge roller 80, the toner surface comes into contact with the discharge roller 80 which is the contact member. Namely, the toner which makes up the toner image on the sheet P is transported in such a state that the toner surface is not in contact with the discharge roller 80, which is the contact member, until the temperature of the toner is reduced to a temperature which is equal to or lower than a melting point or a softening point of the wax or crystalline resin.

To be specific, for example, consider a case where using a toner which contains a wax whose melting point is on the order of 107° C., a toner image is heated and fused on a surface thereof at a temperature of 120° C. by the fusing unit 60. In this case, the toner formed on the toner surface is transported as far as the downstream side in such a state that no contact member is brought into contact with the toner surface until the toner formed on the toner surface is decreased from the fusing temperature of 120° C. down to a temperature which is lower than 107° C., whereby in such a state that the temperature of the toner is higher than the melting point of the wax, the toner which is fused after fusing is brought in no case into contact with the contact member.

In this exemplary embodiment, the belt transport 90 is disposed downstream of the fusing unit 60 in this way, whereby any roller is eliminated which is brought into contact with the image surface in the high temperature state which results immediately after fusing is completed, so that no roller is brought into contact with the image surface until the temperature of the wax in the toner surface is decreased to a temperature which equal to or lower than the melting point of the relevant wax. Because of this, image gloss irregularity is not generated which occurs as a result of the toner surface being and not being brought into abutment with the discharge roller 80.

Furthermore, since the cooling device is provided which cools the toner surface on the transport belt 90, a time period can be reduced which is required to cool the toner surface down to the temperature which is equal to or lower than the melting point of the wax. This can prevent the enlargement in size of the whole image forming apparatus.

Thus, the advantage that the image gloss irregularity is not generated by disposing the belt transport 90 downstream of the fusing unit 60 in the way described above can be obtained remarkably in particular in the high speed machine whose transport speed is 200 mm/s or faster.

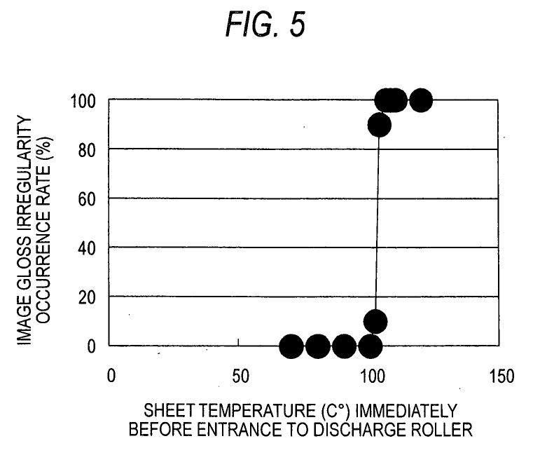

FIG. 5 is a drawing which illustrates a resulting relationship between sheet temperature and image gloss irregularity occurrence frequency. In FIG. 5, the axis of abscissa represents sheet temperature (° C.) which results immediately before the sheet enters the discharge roller 80 (refer to FIG. 4), and the axis of ordinate represents image gloss irregularity occurrence rate (%) which results after the passage of 10 print samples. Here, a toner was used in which, 5 wt % wax (melting point is 107° C.: polyethylene wax P-165 manufactured by Sanyo Kasei Co., Ltd.) was contained.

In addition, the sheet discharge temperature immediately after the fusion by the fusing unit 60 was 120° C. The sheet temperature (° C.) was the sheet temperature (° C.) measured downstream of the transport belt 91 immediately before the sheet entered the discharge roller 80 (refer to FIG. 4).

From the results shown in FIG. 5, it is seen that the sheet (whose sheet discharge temperature was 120° C.) was transported by the belt transport 90 while being cooled, and the sheet temperature became 100° C. which was lower than the melting point (107° C.) of the wax, whereby the image gloss irregularity occurrence rate became 0%. In addition, it is considered that the necessity of the sheet temperature being made lower by 7° C. than the melting point (107° C.) of the wax was due to the temperature of the discharger roller 80 being increased as a result of the passages of sheets therethrough.

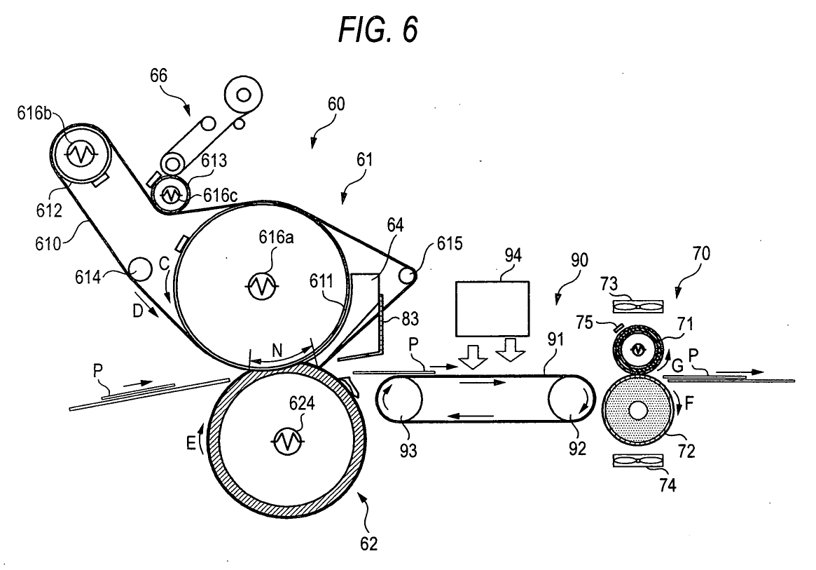

FIG. 6 is a drawing which illustrates an image forming apparatus in which a belt transport 90 and a sheet transport roller 70 whose temperature is controlled are provided downstream of a fusing unit 60. Note that the fusing unit 60 is identical to that described in detail by reference to FIG. 2, and therefore, the description thereof will be omitted herein.

In FIG. 6, the belt transport 90 having a cooling device 94 which is a cooling unit is provided downstream of the fusing unit 60, and the sheet transport roller 70 is provided further downstream of the belt transport 90 whose temperature is controlled to fall in a temperature range which is equal to or lower than a melting point of a wax used. The constructions of the belt transport 90 and the sheet transport roller 70 are identical to those described in detail by reference to FIGS. 3 and 4, and therefore, the description thereof will be omitted here.

As is shown in FIG. 6, a toner image is brought into contact with a fusing belt 610 of the fusing unit 60 to thereby be heated and pressurized, so as to be fused on a sheet of paper P. Following this, the sheet P is transported downstream by a transport belt 91 while a surface on which the toner image exists (a toner surface) is being cooled by air blown out from the cooling device 94. As has been described before, when the sheet P is transported by the transport belt 91, there exists no transport member on the toner surface side, and hence, the toner surface is brought in no case into contact with any contact member. Namely, a toner which makes up the toner image on the sheet P is cooled while being transported in such a state that the toner surface is not in contact with any contact member.

Thereafter, the sheet P reaches a discharge position where the sheet P is discharged by the sheet transport roller 70 and is brought into contact with the sheet transport roller 70, which is the contact member, in a sequential fashion.

As has been described above, the sheet transport roller 70 is held within a temperature range in which the wax or the crystalline resin contained in the toner is not quenched to become amorphous and which is lower than a melting point (° C.) or a softening point (° C.) of the wax or the crystalline resin contained in the toner used by feedback controlling detection information of a temperature detection sensor 75 by a control unit 40. Because of this, the conventional problem is solved that when the sheet P is transported by the sheet transport roller 70, the wax or crystalline substance contained in the toner used is quenched to become amorphous, whereby the resulting toner image becomes highly glossy.

In addition, with the sheet transport roller 70, since an upper roller 71 which is brought into contact with the toner image formed on the sheet P is formed using an elastic layer 712 which is made up of an elastic material, the surface of the roller can be tightly secured to the toner image, and as a result, the image disturbance can be prevented.

Furthermore, in the belt transport 90 which is provided between the fusing unit 60 and the sheet transport roller 70, since the sheet P which is heated by the fusing unit 60 is cooled, the increase in temperature of the sheet transport roller 70 due to the continuous passage of sheets can be suppressed.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An image forming apparatus, which forms an image on a recording material using a toner containing a crystalline substance, the image forming apparatus comprising:
a fusing unit that fuses a toner on the recording material; and
a sheet transport device that transports downstream the recording material on which a toner image is fused by the fusing unit,
wherein the sheet transport device comprises:
a rotating member which comes into contact with the toner image fused on the recording material and has in a sheet's width direction a length of at least a sheet's width; and
a temperature control unit that controls a temperature of the rotating member within a temperature range in which the crystalline substance is not quenched to become amorphous and which is equal to or lower than a melting point of the crystalline substance based on a measured value of the temperature of the rotating member.

2. The image forming apparatus according to claim 1,
wherein the temperature control unit comprises:
a heat source that heats the rotating member;
a cooling element that cools the rotating member; and
a detection sensor that detects the temperature of the rotating member.

3. The image forming apparatus according to claim 2,
wherein the detection sensor is a non-contact type temperature sensor.

4. The image forming apparatus according to claim 1,
wherein the rotating member comprises:
a surface layer which comes into contact with the toner image and comprises a fluorine resin; and
an elastic layer which comprises an elastic material and is formed inside the surface layer.

5. An image forming apparatus, which forms an image on a recording material using a wax or a crystalline resin, the image forming apparatus comprising:
a fusing unit that fuses a toner image on the recording material by a heating system; and
a belt transport that transports downstream the recording material without allowing other members to come into contact with the toner while cooling a surface of the toner on the recording material discharged from the fusing unit to a temperature range in which the wax or the crystalline resin is not quenched to become amorphous and which is equal to or lower than a melting point or a softening point of the wax or the crystalline resin.

6. The image forming apparatus according to claim 5, further comprising:
a cooling unit that cools a surface of the recording material on the belt transport.

7. The image forming apparatus according to claim 6,
wherein the cooling unit forms an airflow which presses the recording material against the belt transport.

8. The image forming apparatus according to claim 5,
wherein a transport speed at which the recording material is transported is 200 mm/s or faster.

9. The image forming apparatus according to claim 5,
wherein the fusing unit comprises:
a fusing belt module in which a belt member is stretched by a fusing roller and a tension roller; and
an impression member disposed such that the impression member presses the fusing roller via the belt member,
wherein the fusing belt module comprises a release member that presses the fusing belt against the impression member downstream and in a vicinity of a press contact portion between the fusing roller and the impression member so as to release the recording material from the fusing belt.

10. The image forming apparatus according to claim 5, further comprising:
a sheet transport device which is provided downstream of the belt transport,
wherein the sheet transport device comprises:
a rotating member which comes into contact with the toner image fused on the recording material and has in a sheet's width direction a length of at least a sheet's width; and
a temperature control unit that controls a temperature of the rotating member within a temperature range in which the wax or the crystalline resin is not quenched to become amorphous and which is equal to or lower than a melting point or a softening point of the wax or the crystalline resin based on a measured value of the temperature of the rotating member.

11. The image forming apparatus according to claim 1,
wherein the temperature control unit controls a temperature of the rotating member within a temperature range of a temperature lower by 10° C. than a melting point of the crystalline substance to the melting point.

12. The image forming apparatus according to claim 5,
wherein the belt transport cools the surface of the toner to a temperature range of a temperature lower by 10° C. than the melting point or the softening point of the wax or the crystalline resin to the melting point or the softening point.

13. The image forming apparatus according to claim 10,
wherein the temperature control unit controls a temperature of the rotating member within a temperature range of a temperature lower by 10° C. than the melting point or the softening point of the wax or the crystalline resin to the melting point or the softening point.
